(19) United States
(12) Patent Application Publication
(10) Pub. No.: US 2008/0005578 A1
(43) Pub. Date: Jan. 3, 2008

(54) System and method for traceless biometric identification

(75) Inventor: Michael Shafir, Kiryat Ono (IL)

Correspondence Address: BRUCE E. LILLING;LILLING & LILLING PLLC, P.O. BOX 560, GOLDEN BRIDGE, NY, 10526, US

(73) Assignee: Innovya Research & Development Ltd., Kiryat Ono (IL)

(21) Appl. No.: 11/478,404

(22) Filed: Jun. 29, 2006

(51) Int. Cl. H04K 1/00

(52) U.S. Cl. 713/186

(57) ABSTRACT

A device, system and method for identifying an individual with a biometric identifier that is designed to be non-unique, such that at least one other individual in a given population has the identical biometric identifier. The biometric identifier according to the present invention, also referred to herein as a “BIdToken”, is implemented to be biometrically traceless, such that an exact image or copy of the biometric information is preferably not maintained by the present invention. Instead, the BIdToken refers to an incomplete identifier obtained from the biometric information, which is non-unique. Preferably the invention operates so as to obviate the obligation to trust a third party.

### BACKGROUND OF THE INVENTION

The prevailing techniques of user authentication, which involve the use of either passwords and user IDs (identifiers), or identification cards and PINs (Personal Identification Numbers), suffer from several limitations. Passwords and PINs can be illicitly acquired by direct covert observation. Once an intruder acquires the user ID and the password, the intruder has total access to the user's resources. In addition, there is no way to positively link the usage of the system or service to the actual user, that is, there is no protection against repudiation by the user ID owner. For example, when a user ID and password is shared with another individual, such as a friend, family member or colleague, the system cannot determine the identity of the actual user, which can be particularly problematic in case of fraud or other criminal acts, or when payment must be made.

A similar situation arises when a transaction involving a credit card number is conducted on the Web. Even though the data are sent over the Web using secure encryption methods, current systems are not capable of assuring that the transaction was initiated by the rightful owner of the credit card since both the real owner and the counterfeiter are using the same transaction initiation process, which is entry of a credit card number and expiration date to the payment system. Indeed, for such transactions even the card itself does not need to be physically present, further increasing the potential scope of fraud and deceptive use of credit card information

Fortunately, automated biometrics in general, and fingerprint technology in particular, can provide a much more accurate and reliable user authentication method. Biometrics is a rapidly advancing field that is concerned with identifying a person based on his or her physiological or behavioral characteristics. Examples of automated biometrics include fingerprint, face, iris, and speech recognition. User authentication methods which employ biometrics can be broadly classified into categories.

However deploying biometric systems without sufficient attention to their dangers makes them likely to be used in a way that is dangerous to civil liberties, because of the inherent property of biometric data, which is that it forms part of the person. A fingerprint, a retinal or iris print, a face or other physical information used for the biometric data are part of the individual. They cannot be changed at all or can only be changed somewhat. Therefore, if the biometric information is used abusively and/or is distributed to third parties, such as law enforcement agencies for example, the individual has little or no recourse, and also cannot change the situation.

Other forms of identification are much less permanent. For example, many if not most individuals in the modern world have a UserID (such as a user name), one or more passwords and one or more Personal Identification Numbers (PIN), which are all different types of information. As they do not form a permanent part of the individual, if this information is stolen, it can be changed. Most individuals in the modern world also have cards, badges and keys, which may be combined with the above information for accessing one or more resources that require identification and authentication. For example an individual typical knows and has an ATM card and an associated PIN. Only the combination of the two items, which is card owning and knowing the PIN, permits the individual to make transaction as example withdrawing money, making a deposit and/or otherwise interacting with ATM machines.

When a PIN and/or PIN plus card are shared with another individual, such as a friend, family member or colleague there is no way for the system to know who the actual card owner is. It means that currently there is no way for the system to know if the previously described items that are defined as ‘knowing’ and “having” have been shared willingly, duplicated, lost or stolen. As described previously, biometrics can be used to overcome these problems but with potential drawbacks.

Biometrics refers to the automatic identification or identity verification of living persons using their enduring physical or behavioral characteristics. Many body parts, personal characteristics and imaging methods have been suggested and used for biometric systems: fingers, hands, feet, faces, eyes, ears, teeth, veins, voices, signatures, typing styles, gaits and odors. A fingerprint for example is a biometric, which if compromised (i.e. obtained in an unauthorized manner) cannot easily be controlled by the individual. An unretouched or altered photograph of a face and a physical signature are biometrics, which can be checked using the eyes and experience of the verifier. These biometrics have been in use routinely and efficiently throughout human history. The use of automation to authenticate people is new and is being tested on consumers without precautions regarding their privacy.

Biometric properties from the perspective of traces or permanent storage can now lead to undesired identification and tracing of the activities of an individual, because of the power of computers. Even if the biometric data is stored in an altered form that requires a complex algorithm to decipher, the speed and computational power available today makes any such protection scheme irrelevant. For example, today anyone with a computer and an electronic telephone book can trace a telephone number to a particular address. Previously before computers, only a governmental entity or authorized authorities such as the police had the right access or permission to trace back the telephone number to a name or location. “Governmental entity” or “Authorities” means the State (country or state/province within a country), any agency, authority, or employee thereof, or any political subdivision of the State, including but not limited to any county, municipality, or school district, or any agency, authority, or employee thereof.

If unique biometric properties are stored somewhere, for example on a smart card or on a computer system, either if it is stored in an encoded, scrambled or ciphered form, it is still a unique biometric identifier. Once a unique biometric identifier has being stored anywhere, at any time, on any external media (including media that is associated with the boundaries of the individual, such as a smartcard held by the individual), the privacy of that biometric property owner is violated or can easily be violated. As noted previously, exposing or losing a biometric property is a permanent problem for the life of the individual, as there is no way to cancel the physiological or behavioral characteristics of the individual. Biometric technology is inherently individuating and interfaces easily to database technology, making privacy violations easier and more damaging.

A unique biometric identification is often far too much information or “overkill” for the task at hand. It is not necessary to identify a person (and to create a record of their presence at a certain place and time) if all that must be known is whether they're entitled to do something or be somewhere. When in a bar, customers use IDs to prove they're old enough to drink, not to prove who they are, or to create a record of their presence. Biometric properties must stay part of its possessor at any time without converting it to a unique digital identifier. A biometric system must be built to the highest levels of data security and should prevent interception, storage, theft to prevent both intrusion and compromise by corrupt or deceitful agents within the organization.

It may seem that one of the issues that plagues token-based ID systems (like ID cards)—the security or integrity of the token itself—does not apply for biometric systems, because “you are your ID.” But the question of the reliability of the token is really a question about trust. In an ID card system, the question is whether the system can trust the card. In biometric systems, the question is whether the individual can trust the system. If someone else captures an individual's physiological signature, fingerprint, or voice print, for instance, abuse by others is difficult to prevent. Any use of biometrics with a scanner run by someone else involves trusting someone's claim about what the scanner does and how the captured information will be used.

Vendors and scanner operators may say that they protect privacy in some way, perhaps by hashing the biometric data or designing the database to enforce a privacy policy. But the end user typically has no way to verify whether such technical protections are effective or implemented properly. End-users should be able to verify any such claims, and to leave the system completely if they are not satisfied. Exiting the system, of course, should at least include expunging the end-user's biometric data and records.

Despite these concerns, political pressure for increasing use of biometrics is increasing. Much federal attention is devoted to deploying biometrics for border security. This is an easy sell, because immigrants and foreigners are, politically speaking, easy targets. But once a system is created, new uses are usually found for it, and those uses will not likely stop at the border.

Many different biometric systems, methods and devices are known in the art, but they all involve capture and storage of a unique biometric identifier. U.S. Pat. No. 7,043,754 describes such a system, in which a memory card stores actual biometric information as a unique identifier, such as fingerprint information for example. Therefore, the fingerprint itself could easily become widely available, either accidentally (for example through data leaks or theft of storage devices with the biometric information stored therein) or purposefully (for example through storage on government and/or police databases).

Similarly, U.S. Pat. No. 7,043,643 describes a system for secure operation of a computer, which also requires the storage of actual biometric information on a smart card and/or other electronic device. The information stored renders the biometric information as a unique biometric identifier, and further permits the fingerprint or other biometric identifier to be reconstructed. U.S. Pat. No. 7,039,221 describes a similar system that is specifically adapted for facial recognition. Another general system is described in U.S. Pat. No. 6,011,858.

U.S. Pat. No. 6,987,870 describes a system for determining destination information that is indexed according to a specific biometric identifier. Again, for the system to operate, the biometric identifier must be unique and furthermore must be reconstructable from the data stored (and/or the exact image itself must be stored).

For U.S. Pat. No. 6,971,031, the explicit goal is to permit tracking of individuals based on their biometric data as stored in an identity card through a national security system. Again, the biometric data is stored on the card as a unique identifier and is clearly meant to be accessible to law enforcement and national security personnel.

U.S. Pat. No. 6,963,659 provides a system in which two heuristic forms of biometric information, fingerprint data and facial recognition parameters, are combined to create a unique biometric identifier. If both types of data are obtained, then the resultant combination is unique. Even if only one type of data is obtained, the system permits this identifier to be unique, such that only the search itself is inexact (for the sake of speed).

U.S. Pat. No. 6,655,585 also describes a system in which the data obtained is exact with regard to the biometric identifier (such that for example an exact fingerprint image is obtained and stored), while the comparison search performed with the identifier can be made more or less heuristic in nature depending upon a statistical threshold level of precision that is required for a desired level of accuracy, for example for uniquely identifying the individual and/or for avoiding false acceptance or false rejection of the presented biometric data.

U.S. Pat. No. 6,192,142 describes a system which permits payment to be made without a credit card or other type of payment token or card. A unique biometric identifier, such as a fingerprint, is obtained from an individual, and is then compared to a database of such identifiers. Once a match has been made, the payment account of the individual can be properly charged without requiring a credit card to be presented. As no additional information is used or required, such as an additional PIN number for example, the system requires the unique biometric identifier to be stored and used, in order to be able to identify the correct account holder.

Similarly, U.S. Pat. No. 7,058,585 relates to a system for providing healthcare benefits without a card, by using a unique biometric identifier such as a fingerprint in place of the card.

U.S. Pat. No. 5,787,186 describes a method for associating facial image recognition with a document, by analyzing the image of the face, associating it with a plurality of predefined templates, each of which has a number, and then printing the number on the document. However, this method is intended to uniquely identify the face of the person as a series of numbers which together form a unique identifier.

U.S. Pat. No. 5,553,155 describes a system for averting welfare fraud, by permitting the recipient to obtain benefits only at certain time slots. The time slot is tied the recipient's biometric characteristics with a unique biometric identifier, such as a fingerprint or facial recognition for example. Clearly such a combination is inconvenient, because the biometric identifier can only be used during a particular short period of time (1-2 hours on a particular day).

U.S. Pat. No. 6,993,166 features a system in which a plurality of biometric images are obtained, such as a plurality of fingerprint images for example, in order to increase the accuracy of identification. However, the images are obtained for the purpose of storage and use as unique biometric identifiers, for uniquely identifying the individual.

U.S. Pat. No. 6,983,882 describes a device for obtaining the biometric information from an individual for securely providing a unique biometric identifier. This device would have the unique identifier stored on it and would perform comparison with a smart card, for example at a POS (point of sale) terminal, but without releasing the unique biometric identifier to an external database. However, this system depends upon the integrity of the device itself and also the security or trustworthiness of the device itself.

U.S. Pat. No. 6,213,391 relates to unique biological signatures as biometric identifiers, particularly with regard to voice prints and voice analysis. This unique biological identifier is preferably obtained with a device that is incorporated into a smart card, in order to prevent an external database from obtaining the biometric information. However, again this system depends upon the unique integrity of the device itself and also the security or trustworthiness of the device itself.

U.S. Pat. No. 6,992,562 describes a system in which the types of access and functionalities permitted to a user are determined according to a unique biometric identifier, which is stored on the system. For example, a wireless device with a database of such unique biometric identifiers could be provided which would include a scanner or biometric reader. The wireless device would ascertain the identity of the user and would then send the information to the remote system. The remote system would then determine which type or types of access may then be provided to the user according to permission(s) stored on the system.

U.S. Pat. No. 6,965,685 describes a method for analyzing a biometric image to determine a unique biometric identifier, such as a fingerprint for example. Similarly, U.S. Pat. No. 6,920,231 describes a method for searching through a plurality of biometric information sets in order to locate and match a unique biometric identifier.

U.S. Pat. No. 6,836,554 attempts to address the privacy aspects of a unique biometric identifier by distorting biometric information, such as a fingerprint image for example, according to a defined algorithm. Therefore, the actual biometric information such as a fingerprint is not stored on the system, but only the distorted version. However, clearly this system could be reverse engineered to obtain the original fingerprint, as otherwise the fingerprint itself could not be input as the unique identifier.

U.S. Pat. No. 6,991,174 relates to a device for obtaining biometric information and optionally other types of secure input, such as a smart card reader, a PIN input device and so forth, in which the device is secured for reading the unique biometric identifier by having only two ports, one for input and one for output. The processing of the data occurs within the device and so cannot be comprised by outside access. However, the data needs to be stored on a smart card and so could theoretically be comprised by transfer to an outside database for example.

U.S. Pat. No. 7,007,298 relates to a unique biometric identifier which is composed of a plurality of biometric features. These features may then be compared to the unique identifier in order to identify the individual. However, because it is intended to be unique, the biometric information could in theory be associated with a unique individual and provided to an external database or system.

US Patent Application No. 20040181675 relates to a system for securely storing and protecting unique signature information about a user; however, the unique identifier could still be connected to a particular individual, and so ultimately the solution does not offer any significant privacy protection.

### SUMMARY OF THE INVENTION

The background art does not teach or suggest a system, device or method that unambiguously authenticate subject's identity without requiring the storage of any unique biometric information, and without the need for linking, writing or binding information to any external device or network or data of every sort. The background art also does not teach or suggest a system, device or method that able to recognize the biometric subject's identity indisputably without at least potentially violating individual privacy.

The present invention overcomes these disadvantages of the background art by providing a device, system and method for identifying an individual with a biometric identifier that is designed to be non-unique, such that at least one other individual in a given population has the identical biometric identifier. The biometric identifier according to the present invention, also referred to herein as a “BIdToken” (Biometric Identifier Token) or non-unique token, is implemented to be biometrically traceless, such that an exact image or copy of the biometric information is preferably not maintained by the present invention. Instead, the BIdToken refers to an incomplete identifier obtained from the biometric information, which is non-unique. By “incomplete” it is meant that the biometric information itself cannot be reconstructed from the BIdToken, because at least a portion and/or aspect of the necessary information is preferably discarded during processing of the biometric information. For example, the BIdToken may optionally and preferably comprise at least a two digit number, preferably a three digit number and more preferably a four digit number, although optionally a number having any number of digits may be employed. In order to avoid accidentally creating a new unique identifier from the biometric identifier, preferably the number of digits is selected according to the size of the population, such that at least one other individual in the population is likely to have a duplicate identifier. The statistical likelihood of the number of individuals having any particular BIdToken may be determined according to the size of the population and the number of digits, such that if a particular degree of overlap is desired, the number of digits for the BIdToken may optionally be selected accordingly.

According to preferred embodiments of the present invention, the BIdToken is not stored on any system or database, such as a bank system for example or other system. Instead, preferably the user provides the BIdToken, which could for example be securely retained by the user in order to maintain control of the BIdToken. For example for an ATM (bank machine withdrawal) card which currently has an associated PIN, the associated PIN could optionally be replaced by the BIdToken. Only the combination of the three items, which is card owning and knowing the exact owning biometric identifier (BIdToken) that replaced the four digits PIN, permits the individual to make transaction as example withdrawing money, making a deposit and/or otherwise interacting with ATM machines. In this new situation when a PIN and/or PIN plus card are shared with another individual, such as a friend, family member or colleague, or is stolen by a thief, the identity of the individual using the card will be known, such that only the true owner can use the card. The method for determining the BIdToken is preferably kept secure as described in greater detail below, such that it is preferably not possible to determine the non unique BIdToken formation from the fingerprint or other unique biometric identifier by an unauthorized party (for example by reverse engineering). Furthermore, this embodiment could optionally be used for any situation in which a PIN is required, such that the BIdToken would replace the PIN. This embodiment neutralizes the obligation requirements for trust by third parties.

Alternatively the BIdToken may optionally be retained, preferably in relation to the identity of a particular user (such as being related to a name and/or account number for example), such that the retained BIdToken is optionally compared to the BIdToken information determined from the biometric information presented by the user.

According to the present invention, the biometric identifier used for constructing the BIdToken may optionally comprise any physiological trait or a combination thereof, including but not limited to the pattern of a finger (fingerprint), face recognition, the pattern of the palm of a person's hand (palmprint), a EEG (brainwaves) trace signature, a voice pattern, retinal eye scan, etc. A fingerprint, voice print or face recognition are preferred forms of biometric identifiers according to the present invention, but the present invention is not limited to these identifiers (singly or in combination). For example, a minutiae, pattern or spectral sensor, Iris, Hand Geometry, Palm Vein, Signature/Sign (preferably regarding speed for creating it and/or the image produced thereof), Keystroke Alterable, voice sensor, camera for 2D or 3D face recognition system, or any other type of biometric sensor or scanner may optionally be used.

Each of these biometric modalities captures data describing either image-based (but not necessarily constant) characteristics of the individual or alterable characteristics, which can incorporate time-stamp data. These two different technologies have previously been differentiated by the terms “physiological” and “behavioral” the terminology is a more accurate reflection of what is captured. Capture of data for physiological characteristics is sometimes mistakenly considered to be equivalent to the characteristic itself. For instance, whereas someone's fingerprints may remain constant for a long time, it is not the case that the capture of fingerprint data is consistent from one measurement to the next, as one of the variables is human behavior. Thus, so-called physiological biometric systems are also behavioral and should take into account the effects of human behavior on the analyses.

The biometric sensor can optionally include a scanning mechanism adapted for placing a finger thereon or a camera or other snapshot device. The biometric sensor can further include an optical image sensor, which may include a complementary optical sensor, a charge coupled device (CCD) optical sensor, or any other optical sensor having sufficient resolution to provide an acknowledged indicative of a biometric image. In the embodiments with an optical sensor, the capturing device would include an optical scanner, and the biometric sensor may also include a lens focusing light from the scanner onto the optical sensor. The biometric sensor can alternatively include a direct contact sensor device, such as a capacitive sensor chip or thermal sensor chip or CCD chip, one or more CPU chips and one or more Algorithmic Logic Units (ALU) to provide the Biometric-Token-Identifier allocation or verification processing. The processing unit can include a processor circuit and a volatile memory to avoid storing any original biometric traces and/or information, such that the verification acknowledgement optionally and preferably includes determining the non-unique BIdToken by the ALU. In one embodiment, the BIdToken device includes an ALU circuit and a keypad to accept entry of the BIdToken indicative of the person being examined, in order to optionally avoid storing the BIdToken itself in an external system.

In another embodiment, the BIdToken comprises a derivative algorithm programmed into the processor. The derivative algorithm preferably employs different private key algorithms to create the BIdToken indicative of the surveyed person such that the token is only generated according to that algorithm in a particular system. In this embodiment, the allocation unit can further include a different circuit or different ALU's or algorithms. The memory on any case is preferably volatile, and any sort of unique biometric characters should not be stored or transmitted anywhere to or from this system, in order to prevent encoding or decoding any unique identifier/s from the original biometric characters, and to keep the solution completely traceless, thereby neutralizing the obligation requirements for trust by third parties.

The processor unit can optionally be further adapted to first cause the allocation circuit to display or print a BIdToken acknowledgement indicative of the unique scanned characteristic obtained by the scanning system to the authenticating system.

The authenticating circuit can optionally be adapted to receive a keypad response acknowledgement transmitted by the keypad system in response to the BIdToken code input. The processor unit employs the BIdToken algorithm results to create the verification acknowledgement, and causes the display or output circuit to accept the verification signal to the reading unit system only if the input keypad BIdToken acknowledgement corresponds sufficiently to the original scanned biometric characteristics.

In another embodiment, the use of Alterable Biometrics which incorporate time-stamp data provides the ability of the surveyed process to introduce a fundamental secret, which is under the control of an individual, into the biometric process. For instance, the users of signature and/or sign biometrics can enroll with “signs” of their own choice which may or may not be their signatures. According to the known background art, the signature is actually exposed and might be reproduced by the recoding system in the same secret manner. The new way of solving this issue is not recording the secret reproduction but instead optionally a non unique Biometric Token that can represent secretly that the secret sign manner is identical and belongs to its owner as it fits the stored BIdToken. A person's signature can be considered to be a non-secret, special case of a sign in this modality. If the biometric surveying process inhibits the display and the motional and the time-stamp records of the sign and deletes the raw sample data after extracting the biometric features to a BIdToken, then there is a high degree of secrecy associated with the sample. The biometric process therefore optionally and preferably combines both a secret (sign) and the associated biometric token into one operation giving it two-factor authentication status.

Furthermore because there are an infinite number of different secret samples that one individual can generate using alterable biometrics, the revocation of the BIdToken for whatever reason, requires no more than a re-survey process. The re-surveys of different secret samples can be undertaken at any time in the same way that passwords can be changed.

In another embodiment, voice systems may contain secret words or phrases in the biometric samples, to be compared with a derivative Token template which could be used to authenticate the sample based upon either the secret phrase or the natural voice data (independent of the secret phrase) or both. Likewise, handwriting can employ a secret “keyword sequence” (BIdToken) with the associated sample. In this manner the biometric samples and the Token templates can be chosen at will by the user and are therefore “alterable” as well as secret. The degree to which these samples are “secret” depends upon the way in which the process avoids eavesdropping (physical or electronic), whether the sample data are deleted after capture, and if not, how they are protected. These problems are no different from the same problems associated with passwords and PINs, hence the BIdToken can be a good replacement since it has no true value except in a particular biometric identification transaction occasion to avoid association with recorded passwords or biometric signatures or any other unique characteristics. The biometric identifier token has the huge advantage over passwords and PINS that even if the sign, phrase or keyboard sequence is physically known to the impostor, it is still extremely difficult for an impostor to reproduce it. Alterable biometrics therefore preferably combine secrets with biometric samples to provide two-factor authentication in one process.

According to another aspect of the invention for using BIdToken in open networks, a portable, hand-held personal identification device for providing secure access to a host facility includes housing. Where the alterable biometric process involves a secret it is possible to build that knowledge into the places limits or acceptable ranges of values on monitored conditions setting and to make the BIdToken characteristics more user-friendly without sacrificing the security of the overall biometric surveyed process. Further security can be added, unlike all biometric systems, by requiring the use of a BIdToken only without transmitting out the biometric sample. In the case of the alterable biometric technology, the authentication process would then involve two secrets, the token and its biometric scan results. The BIdToken would have a multiplicative effect upon the inherent entropy of the biometric data, which contain both a secret and a biometric sample. When a biometric sensor is at a remote or unobserved site there is a higher chance of spoofing. Biometric systems can introduce challenges to the individual at the time of sampling and verify that the correct response to that challenge is within the biometric sample. These challenges are secrets. In the case of voice, for instance, the spoken phrase might contain the spoken token and in the case of the sign, this might contain the handwritten BIdToken itself. In each case the server would extract this information from the biometric representative token together with the account number to verify the correct response to the challenge. This technique allows the system to provide for a live acknowledgement which could utilize requested data in the sample or separate data entered using the screen or keyboard.

A biometric sensor system in the housing is optionally and preferably capable of sensing a biometric characteristic/s of a user and providing a biometric identifier indicative thereof. The biometric sensor system includes a biometric scanner or a camera or any other snapshot adapted to receive any biometric scan input. A separate communication unit preferably includes the ability to receive from the biometric authenticator scanner acknowledgements, transmitting circuits that send out only the authenticating approval or a token without need for any recordable smart cards or memory. A processing circuit in the device is adapted to cause the BIdToken typed code acknowledgement from the individual to be read by the circuit keypad. The processing circuit is further adapted to cause a host response acknowledgement received by the receiving circuit from the host system in response to the BIdToken code signal to be compared according a derivative biometric algorithm employing the personal encryption key and to cause the acknowledge host response acknowledge to be transmitted the verification acknowledge only if the fingerprint characteristics corresponds sufficiently to the fingerprint Token to verify that the user is the registered person.

According to preferred embodiments of the present invention, there is provided a method for biometric identification of a user, comprising: obtaining biometric information from the user; determining a non-unique token from the biometric information; and comparing the non-unique token to a previously determined non-unique token to identify the user. Preferably the determining the non-unique token comprises a lossy method. More preferably, the biometric information is not stored permanently. Most preferably, the non-unique token is not stored. Also most preferably, the non-unique token is entered by the user.

Optionally the non-unique token comprises a numeric string and/or a symbolic string.

Optionally the non-unique token is stored or retained. Preferably, storage of the non-unique token is controlled by the user, which may optionally be an physical item, optionally comprising a card for example.

Optionally the non-unique token is stored on a device not controlled by the user.

According to other preferred embodiments of the present invention, there is provided a method for identifying a user for performing a transaction, comprising: obtaining biometric information from the user; determining a non-unique token from the biometric information; comparing the non-unique token to a previously determined non-unique token to identify the user; providing an additional form of identification; and if the additional form of identification and the non-unique token match, performing the transaction.

Optionally the performing the transaction comprises performing a financial transaction. Also optionally the financial transaction comprises at least one of performing a function at an ATM or purchasing an item at a point of sale.

Preferably the determining the non-unique token comprises a lossy method. More preferably, the biometric information is not stored permanently.

Optionally and preferably the non-unique token is not stored. More preferably, the non-unique token is entered by the user. Most preferably, the non-unique token comprises a number.

Alternatively the non-unique token is stored. Preferably the non-unique token is stored on an item controlled by the user. More preferably, the item comprises the second form of identification. Most preferably the item comprises a card.

Alternatively, the non-unique token is stored on a device not controlled by the user. Optionally, the non-unique token comprises a number.

According to still other preferred embodiments of the present invention, there is provided a system for providing access to a restricted resource, comprising: a biometric device for obtaining biometric information from the user and converting it to a non-unique biometric token; a gatekeeper for comparing the non-unique token to stored information about the user and for determining whether to grant access according to the comparison. Optionally the system further comprises a non-biometric identification reader for receiving a second type of non-biometric identification and for granting access according to the second type of information and the comparison.

Optionally the restricted resource comprises one or more of a bank account, another financial system, a secure host facility. Also optionally the secure host facility is selected from the group consisting of a store, a military base, a computer system, an automobile, a home security system, a gate, or any other facility where it is desired to restrict access.

According to yet other preferred embodiments of the present invention, there is provided a device for biometric identification of a user, comprising: a. a biometric sensor for obtaining biometric information; b. a processor for converting the biometric information to a non-unique biometric identifier; and c. a port for providing the non-unique identifier but for not providing the biometric information.

According to still other preferred embodiments of the present invention, there is provided a method for creating a non-unique identifier for a user, comprising: obtaining unique biometric information from the user; and determining the non-unique token from the biometric information.

Preferably, determining the non-unique token comprises a lossy method for losing at least some information. More preferably, the unique biometric information is not stored permanently. Most preferably, the non-unique token is not stored. Also most preferably, the non-unique token comprises a string selected from the group consisting of a symbolic string and a numeric string.

Optionally and alternatively, the non-unique token is stored. Optionally and preferably, storage of the non-unique token is controlled by the user. Preferably, the storage comprises a physical object.

Optionally and preferably, the biometric information comprises at least one of a fingerprint, facial recognition, a voiceprint, EEG (brainwaves) trace signature, retinal eye scan, iris scan, hand geometry, palm vein pattern, signature creation speed, sign creation speed, signature image, sign image, keystroke pattern, teeth pattern, gait characteristics or odors or a combination thereof.

Optionally and preferably the method further comprises determining access to a restricted resource at least partially according to the non-unique token. Preferably, the restricted resource is selected from the group consisting of a bank account, a financial system, a computer system, and a secure host facility. More preferably, the secure host facility is selected from the group consisting of a bank, a store, a military base, an automobile, a home security system, a gate, or any other facility restricting access to selected individuals.

Optionally, storage of the non-unique token is controlled by the restricted resource.

Optionally, determining the non-unique token from the biometric information comprises processing the unique biometric information for reproducibly producing the non-unique token according to at least one biometric characteristic. Preferably, the processing comprises converting the unique biometric information to at least one of a numeric string or a symbolic string. More preferably, the converting is for at least one numeric string and the processing further comprises performing at least one mathematical operation for reducing an amount of information in the numeric string.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager, TV decoder, game console, digital music player, ATM (machine for dispensing cash), POS credit card terminal (point of sale), electronic cash register. Any two or more of such devices in communication with each other, and/or any computer in communication with any other computer, may optionally comprise a “computer network”.

By “online”, it is meant that communication is performed through an electronic communication medium, including but not limited to, telephone voice communication through the PSTN (public switched telephone network), cellular telephones or a combination thereof; exchanging information through Web pages according to HTTP (HyperText Transfer Protocol) or any other protocol for communication with and through mark-up language documents; exchanging messages through e-mail (electronic mail), messaging services such as ICQ™ for example, and any other type of messaging service; any type of communication using a computational device as previously defined; as well as any other type of communication which incorporates an electronic medium for transmission.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A and 1B are flowcharts of an exemplary illustrative method according to the present invention for creating a BIdToken for fingerprint (FIG. 1A) or face recognition (FIG. 1B);

FIG. 2 is a flowchart of a more detailed exemplary illustrative method according to the present invention for comparing the previously allocated BIdToken to a currently determined BIdToken;

FIG. 3 is a schematic block diagram of an exemplary system according to the present invention for creating a BIdToken and/or checking an offered BIdToken against a stored BIdToken;

FIG. 4 shows an exemplary device according to the present invention for operation with the system of FIG. 3;

FIG. 5 shows another exemplary device according to the present invention for operation alone or with the system of FIG. 3;

FIG. 6 shows a flowchart of an exemplary method for using a BIdToken with an ATM (cashpoint or automatic banking) machine according to the present invention; and

FIG. 7 shows a flowchart of an exemplary method for purchasing one or more items with a BIdToken according to the present invention.

### DESCRIPTION OF THE PREFERRED EMBODIMENTS

The present invention is of a system and a method for identifying a user according to a non-unique biometric identifier, which is preferably an incomplete biometric identifier. It is incomplete in the sense that preferably it is not possible to re-access or determine the original biometric information through a reverse algorithm due to the loss of information during the creation of the non-unique biometric identifier, as referred to herein as a BIdToken or as a non-unique token. The BIdToken may optionally and preferably be implemented as a number or numeric string with sufficiently few digits that it may not itself be unique for the population of individuals from which such information is being collected. It may also optionally be implemented as a string of symbols. Of course, it is understood that that the BIdToken may be unique with a population, as there may not be another such BIdToken, such that the present invention preferably operates according to statistical likelihood of overlap rather than actual overlap.

According to preferred embodiments, the system according to the present invention preferably features two standalone separate elements: “BIdToken Allocator” and “BIdToken Identifier”.

Optionally and preferably, one or both of such elements can operate autonomously without being connected to any cables or transceivers or any external system, card, or any other devices. With regard to the BIdToken Allocator, preferably it is able to provide the BIdToken through analyzing the biometric information in order to determine the BIdToken from this information. The allocator operates such that if the same biometric information is obtained from the same individual, then the analysis performed on this biometric information results in the same BIdToken being obtained. Furthermore, preferably the allocator operates through loss of information, such that possession of the BIdToken is not sufficient to reconstruct the biometric information (for example, to reconstruct the fingerprint if a fingerprint is used to determine the BIdToken).

For identification purposes, again the BIdToken Identifier is preferably not connected to an external system. Optionally and more preferably, if a connection is required to an external system, the connection more preferably only features a “yes” or “no” response regarding a match with a stored BIdToken. The BIdToken Identifier device is preferably able to determine the identity of any number of biometric subjects indisputably. The BIdToken Identifier preferably can be used to verify the identity of persons without violating their privacy and without storing the exact biometric identifier or biometric information, such that the biometric identifier according to the present invention is traceless.

As described herein, the BIdToken itself is preferably not unique according to the population of individuals on which the BIdToken identifier operates. The statistical property of non-uniqueness, or at least the possibility of non-uniqueness, depends upon the number of individuals in the population and the number of digits in the unique identifier. For example, for a four digit number, one of every 9999 specimens has the same BIdToken identifier result as at least one other BIdToken, such that it has the possibility of non-uniqueness.

According to preferred embodiments of the present invention, only the BIdToken is stored, and is more preferably not stored on an external system, but instead is preferably stored on a localized device, which is preferably held, retained or controlled by the user, thereby obviating the obligation to trust a third party. A non-limiting example of such a device is a memory card, such as a contact or contactless chip or card, which may be provided by the user. Alternatively the user may enter the BIdToken manually (for example from memory) to an external system. The external system then optionally and preferably performs BIdToken identification from the biometric information of the user, through a biometric reader or device of some type, as is known in the art. Preferably, the external system comprises a device according to the present invention for performing the BIdToken identification method in order to compare the biometric information of the user to the BIdToken itself, which more preferably does not permit the storage of any biometric information and also more preferably does not permit access to the method according to which the BIdToken is generated, thereby avoiding breaches of security.

According to other preferred embodiments of the present invention, since the BIdToken itself is preferably non-unique, a second form of identification is preferably presented, for example to the above described external system. As a non-limiting illustrative example, an ATM machine (banking machine) may optionally comprise such an external system. The user preferably presents an ATM card while also at least permitting the biometric information to be obtained, for example by having a fingerprint scanned with a fingerprint reader. The scanned fingerprint information is then used to determine the BIdToken, and to compare the previously determined BIdToken to the currently determined BIdToken. The previously determined BIdToken is preferably entered, for example manually and/or by reading a card, or is alternatively optionally stored. If the two match, and the user also provides the correct or matching card, then the user is able to obtain money and/or perform some other banking function with the ATM machine.

The other form of identification may optionally comprise any type of physical item such as a card, key, chip and so forth and/or any type of information entered by the user, including one or more of medical, security, insurance, entertainment, hospitality, financial, travel, general business and law enforcement information.

The present invention enables fraud, theft and unauthorized use of various resources to be blocked because the combination of the BIdToken and the second form of identification are effectively unique, even though the BIdToken itself is preferably not unique. For example, a credit card and/or banking card cannot be stolen and used in an unauthorized manner, since the thief is preferably statistically extremely unlikely to have biometric information that would result in the same BIdToken being generated. The relative statistical likelihood or unlikelihood is preferably determined according to a combination of the population for which BIdTokens are being provided and the number of digits for the BIdToken, as previously described.

A similar situation arises when a transaction involving a credit card number is conducted on the Web as the use of biometric Token Identifier according to the present invention is able to assure that the transaction was initiated by the rightful owner of the credit card, because the BIdToken is a sufficient identifier in combination with a credit card number or other account identifier, even if not unique, since individuals cannot easily change their own intrinsic physiology or physical appearance to conform to another BIdToken; furthermore if the method for creating the BIdToken is kept secure from being recreated or reverse engineered, an unauthorized user would not easily be able to determine how to create a false BIdToken.

Other exemplary applications include but are not limited to identification of an individual at a border, for example at an airport, for accessing a secured area, for receiving governmental benefits (including but not limited to welfare and health benefits) and for accessing one or more computer resources.

The principles and operation of the present invention may be better understood with reference to the drawings and the accompanying description. It should be noted that all drawings as shown herein are logic drawings and are schematic in nature, such that the actual physical implementation could actually be quite different.

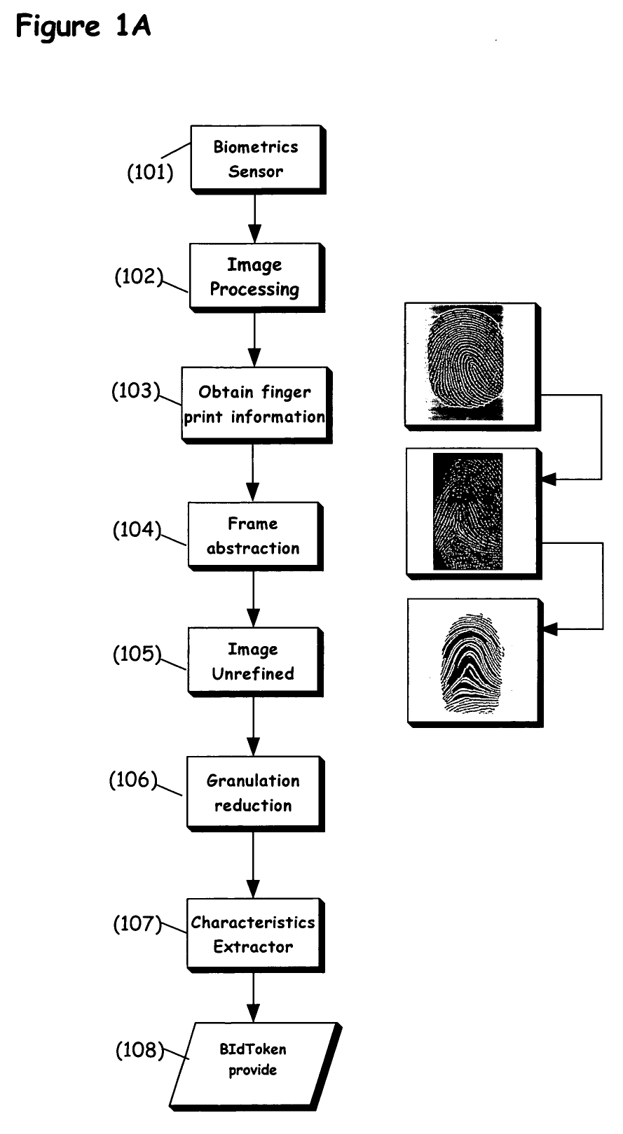

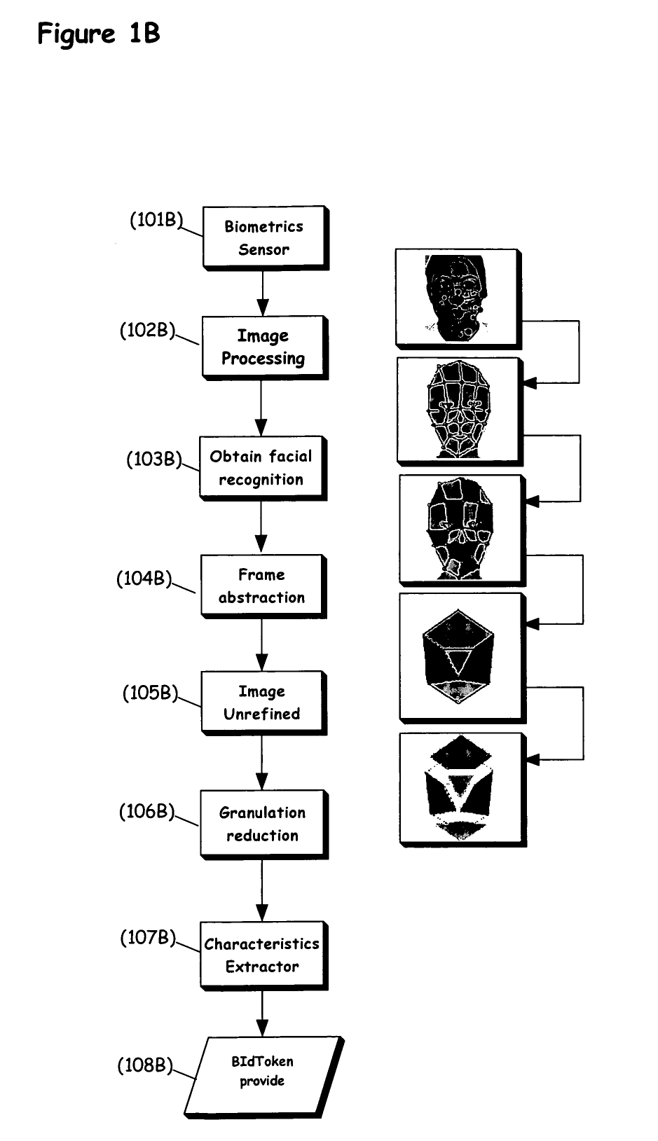

Referring now to the drawings, FIGS. 1A and 1B are flowcharts of an exemplary illustrative method according to the present invention for creating a BIdToken from a fingerprint (FIG. 1A) or face recognition (FIG. 1B; although fingerprint information is described with regard to FIG. 1A and facial recognition is described with regard to FIG. 1B, it is understood that optionally any type of biometric information may be used.

Turning now to FIG. 1A, as shown in stage 101, in this non-limiting example, at least fingerprint biometric information is preferably obtained, for example with a biometric sensor and/or scanner as shown (although the present invention is not limited to operation with a biometric sensor and/or scanner).

In stage 102, image processing is performed to obtain an image of the fingerprint. In stage 103, fingerprint information is preferably obtained from the image. Obtaining fingerprint information may optionally be performed according to any algorithm that is known in the art. It should be noted that at this stage, optionally the fingerprint information is sufficiently detailed to reconstruct the fingerprint or at least to be able to recognize it again uniquely.

The biometric information may optionally be converted by using a directly “lossy” method, such that the converted information cannot be used to reconstruct the fingerprint (or to recognize the fingerprint again) in any case. Such an embodiment may be preferred when the biometric information is being obtained by an external system which may not keep the obtained information in a “closed” or protected environment, in order to prevent the unique biometric information from being inadvertently or deliberately stored while performing the method of the present invention.

U.S. Pat. No. 5,787,186, hereby incorporated by reference as if fully set forth herein, describes a method for converting biometric information to a number, such as fingerprint information for example. The disclosed method also converts fingerprint information (for example) to a plurality of master or pattern features, from which a unique identifier number is obtained. A neural network may optionally be used to analyze the fingerprint in order to obtain these features. Since the present invention only uses this information as a starting point, any type of recognition method may optionally be used to locate a plurality of features of the biometric information, as long as the results of the method are reproducible, regardless of whether they result in an accurate identification of the unique fingerprint. Indeed, as noted previously, the method of the present invention is preferably lossy in order to prevent an exact duplicate of the biometric information from being obtained at any stage, such that the method produces preferably incomplete information.

An exemplary method for fingerprint processing is described with regard to U.S. Pat. No. 6,484,260, hereby incorporated by reference as if fully set forth herein, which includes obtaining an image of the fingerprint and/or visual data regarding at least a part of the fingerprint, to provide a fingerprint signal. This signal may then optionally be converted to a number.

Another method which could optionally be used to process the biometric information is described in U.S. Pat. No. 6,965,685, hereby incorporated by reference as if fully set forth herein. The method features comparing areas of light and darkness, and could be suitable for use herein if a number is then generated from the analysis of the image.

Of course, optionally any method as is known in the art could be used to perform stage 103 of the present invention as described herein.

In stage 104, processing of the fingerprint information is preferably performed to further abstract it in a lossy manner, for example by selecting a plurality of specific features as shown and determining their relative geometry and/or distances. According to the example shown, this process may optionally be performed according to frame abstraction.

In stage 105, further processing may optionally be performed, for example to lose further information by changing shades of gray to black/white coloring by area as shown. This process actually unrefines the image, to preferably extract only the absolute features of the fingerprint and to therefore remove details from the image. In stage 106, a further degree of abstraction may optionally be performed, resulting in a further loss of information, by separating the fingerprint information into polygons. Optionally and preferably, this process may be performed as shown by a granulation reduction process.

The above stages are shown with a representative but exemplary and non-limiting set of pictures, which show the processing of the fingerprint image to obtain abstracted fingerprint information.

In stage 107, optionally and preferably the above obtained information is processed to obtain one or more characteristics that are representative of the biometric information. By “representative” it is meant that the method is sufficiently reliable to always produce the same characteristic(s), such as a number for example, upon presentation of the same biometric information, although the characteristic(s) such as a number would not necessarily be sufficient to reconstruct the biometric information by reversing the method, as the method is optionally and preferably lossy as previously described.

The number is used to obtain the BIdToken which as previously described is preferably non-unique. It should be understood that substantially any method could be used, for example by associating a number with each polygon to create a string and optionally including performing one or more mathematical operations on the string or a portion thereof. One or more parts of the string may optionally be selected to form the BIdToken. In stage 108 optionally and preferably the created BIdToken is provided, optionally according to one or more of being displayed and/or printed and/or stored and/or otherwise provided for future use as a comparator.

FIG. 1B shows a flowchart of an exemplary method for creating a BIdToken from facial recognition according to the present invention.

As for FIG. 1A, in FIG. 1B the process starts with preferably obtaining at least facial recognition biometric information, for example with a biometric sensor and/or scanner as shown (although the present invention is not limited to operation with a biometric sensor and/or scanner) in stage 101B.

In stage 102B, image processing is performed to obtain an image of the face. In stage 103B, facial recognition information is preferably obtained from the image. Obtaining facial recognition information may optionally be performed according to any algorithm that is known in the art. It should be noted that at this stage, optionally the facial recognition information is sufficiently detailed to reconstruct the face or at least to be able to recognize it again uniquely.

For example, U.S. Pat. No. 5,386,103, hereby incorporated by reference as if fully set forth herein, describes an exemplary method for obtaining human facial image projection characters. The characters may optionally be obtained by using a video camera to scan the face, followed by digitizing the image (unless the image is optionally obtained in a digitized form directly). A neural network is then optionally used to extract a plurality of facial recognition characters from the digitized image, for example by converting the digitized image to a matrix of numbers and using eigenvectors and eigenvalues to assess this matrix. These characters may optionally be used collectively to describe the face, and hence to form a basis of the present invention. More preferably the characters are converted to numbers for subsequent stages of the method as described below.

Optionally any of the above exemplary methods described for fingerprint processing may be implemented as appropriate.

In stage 104B, processing of the facial information is preferably performed to further abstract it in a lossy manner, for example by selecting a plurality of specific features as shown and determining their relative geometry and/or distances. According to the example shown, this process may optionally be performed according to frame abstraction.

In stage 105B, further processing may optionally be performed, for example to lose further information by changing shades of gray to black/white coloring by area as shown. This process actually unrefines the image, to preferably extract only the absolute features of the face and to therefore remove details from the image. In stage 106B, a further degree of abstraction may optionally be performed, resulting in a further loss of information, by separating the facial information into polygons. Optionally and preferably, this process may be performed as shown by a granulation reduction process.

The above stages are shown with a representative but exemplary and non-limiting set of pictures, which show the processing of the facial recognition image to obtain abstracted facial information.

In stage 107B, optionally and preferably the BIdToken is created from these polygons, for example by assigning each polygon a number and using that number to create the BIdToken, for example by including each number as a digit of a numeric string that forms the BIdToken, optionally including performing one more mathematical operations on the string and/or selecting a part of the string. As described above, optionally any mathematically reproducible method may optionally be used to create the BIdToken.

In stage 108B, optionally and preferably the created BIdToken is displayed and/or printed and/or stored and/or otherwise provided for future use as a comparator.

One or more of the above embodiments may optionally be implemented for use with another embodiment as described in greater detail below.

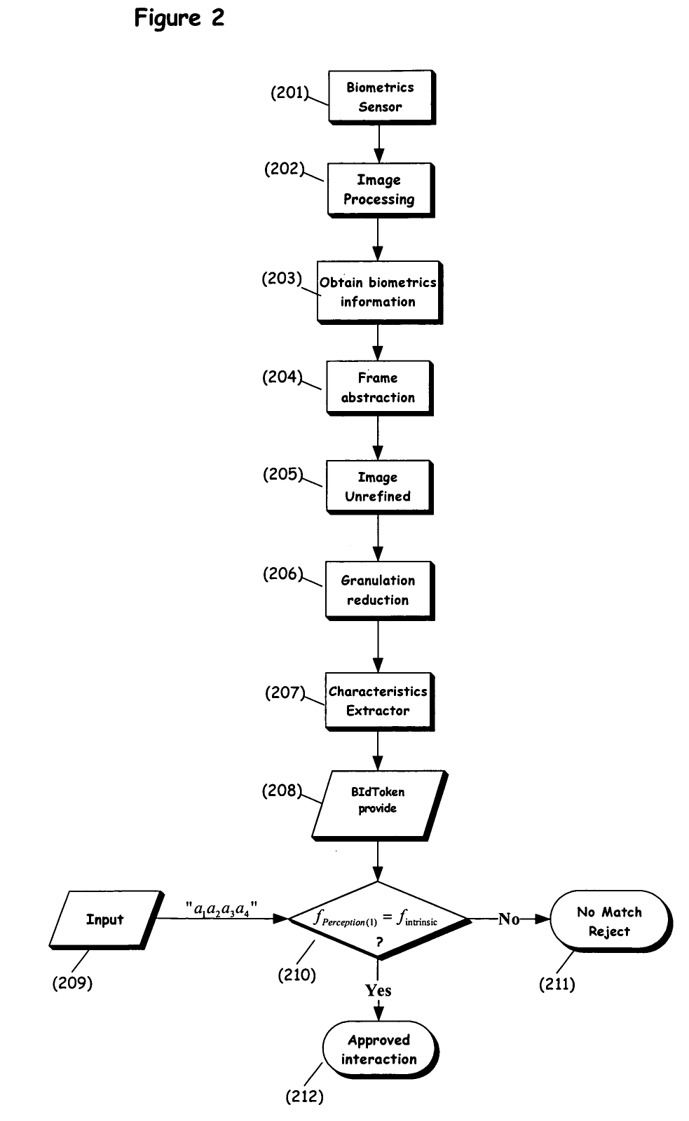

FIG. 2 is a flowchart of a more detailed exemplary illustrative method according to the present invention for comparing the previously allocated BIdToken to a currently determined BIdToken, for example for fingerprint or face recognition and/or any other biometric information.

As shown in FIG. 2, stages 201-207 optionally and preferably mirror the previously described process of stages 101-107 for FIG. 1A and/or 101B-107B for FIG. 1B.

In stage 208, optionally and preferably the currently determined BIdToken is provided for the next part of the process.

In stage 209, optionally and preferably the previously determined BIdToken is input, for example by entered manually by a user (for example through a keypad or other entry device as described below) and/or from a card or other storage device controlled by the user. Alternatively the BIdToken is stored at a storage device or location that is not controlled by the user, for example which is controlled by a third party.

In stage 210, the BIdToken currently obtained is preferably identical to the previously determined BIdToken against which identification is being performed. If there is no match then it is preferably rejected in stage 211; if there is a match then it is preferably accepted in stage 212 and the interaction is preferably approved.

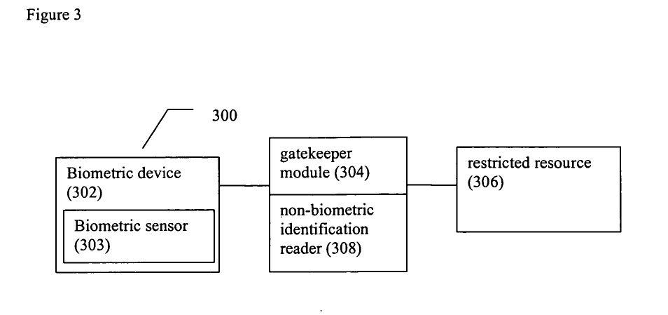

FIG. 3 is a schematic block diagram of an exemplary system according to the present invention for creating a BIdToken and/or checking an offered BIdToken against a previously determined BIdToken. As noted previously, optionally and preferably the same method for creating the BIdToken is used as the first part of the method for identifying a user according to a previously created BIdToken.

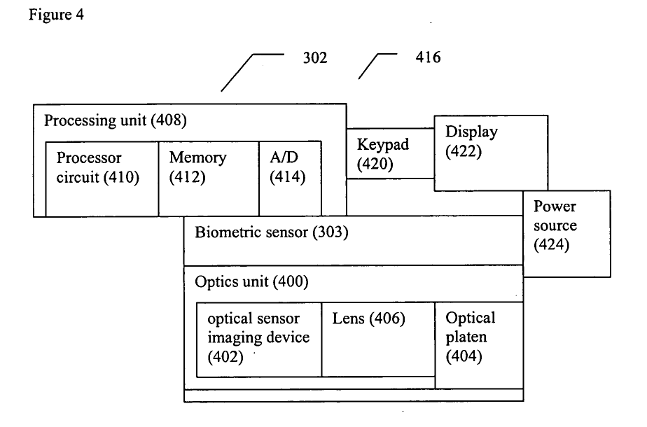

A system 300 as shown preferably features a biometric device 302, described in greater detail below with regard to FIG. 4. Biometric device 302 preferably features a biometric sensor 303, although optionally a plurality of biometric sensors 303 may be provided (not shown) for registering different types of biometric information. Biometric sensor 303 may optionally detect any type of biometric information as described herein, including but not limited to fingerprint, palm print, iris pattern, retinal print, or voice print. Biometric sensor 303 can include a fingerprint sensor, a voice sensor, or any other type of biometric sensor. The fingerprint sensor can include a platen adapted for placing a finger thereon. The fingerprint sensor can alternatively include a direct contact sensor device, such as a capacitive sensor chip or thermal sensor chip. In these embodiments, the platen would be the surface of the sensor chip.

Biometric device 302 is preferably in communication with a gatekeeper module 304, which determines whether access may be granted to a restricted resource 306. Restricted resource 306 may optionally be selected from the group including but not limited to a bank account or other financial system, and/or a secure host facility, including but not limited to a bank, a store, a military base, a computer system, an automobile, a home security system, a gate, or any other facility where it is desired to restrict access to selected individuals.

A user (not shown) is evaluated by biometric device 302 (or alternatively by a different device (not shown)), to obtain biometric information which is used to create a BIdToken. Optionally and preferably, the method for creating and/or determining the BIdToken is performed at biometric device 302 although alternatively it may optionally be performed at gatekeeper module 304. The BIdToken is preferably non-unique, such that the user is preferably required to present at least one other type of identification in order to access restricted resource 306. Therefore, gatekeeper module 304 preferably also comprises a non-biometric identification reader 308, for reading the second type of identification. Gatekeeper module 304 then preferably compares the previously determined BIdToken to the offered BIdToken from the user, and also preferably compares the non-biometric identification to any stored non-biometric identification information. If the previously determined BIdToken is not stored at a location controlled by gatekeeper module 304 and/or some other trusted location (not shown), then preferably the previously determined BIdToken is presented by the user, optionally and preferably by entering the BIdToken manually and/or by presenting a card with the previously determined BIdToken on it, as described in greater detail below.

Among the advantages of not storing the BIdToken is that lack of storage by a third party (i.e. a part other than the user who presents the biometric information) neutralizes the obligation requirements for trust by third parties. However, such an embodiment also preferably includes protection for the method for determining the BIdToken in a secure manner, for example by securing biometric device 302 such that the method cannot be determined from observing the behavior of biometric device 302 and/or by including at least one other additional factor as a private key that is known to the user but which may optionally and preferably be different for different users, such as which finger to present for a fingerprint, a word or phrase to be stated when making the voice print, an expression on the face for facial recognition and so forth.

According to the comparison of the previously determined BIdToken to the offered BIdToken from the user, gatekeeper module 304 determines whether to permit access by the user to restricted resource 306.

According to preferred embodiments of the present invention, as described in greater detail below, biometric device 302 does not feature a writable memory, such that biometric device 302 is not capable of storing additional information after manufacture. This embodiment is preferred because as described previously, the present invention preferably does not store any complete biometric information but rather only uses it to generate the BIdToken for the purpose of creating and/or checking it. Biometric device 302 is also preferably sealed, such that biometric device 302 optionally and preferably cannot export any information other than the BIdToken, and according to preferred embodiments described above may optionally even be unable to export the BIdToken itself, rather only providing a “yes” or “no” answer regarding a match. Instruction(s) for performing the method of determining the BIdToken are optionally and preferably burned on a chipset or some other secure type of hardware and/or firmware.

According to other preferred embodiments of the present invention, system 300 is implemented through a network such as the Internet and/or a bank or ATM network, or optionally any other type of network, for permitting remote authentication of the user. One of ordinary skill in the art could easily implement the present invention with such a network.

FIG. 4 is an exemplary biometric device according to the present invention for operation with the system of FIG. 3, presented in greater detail.

As shown, biometric sensor 303 in biometrics device 302 preferably includes an optics unit 400 having an optical sensor imaging device 402 such as a CMOS device for example, and an exposed optical platen 404. Imaging device 402 can also be a CCD imaging device. A lens 406 may also be used to focus an image from a surface of platen 404 onto imaging device 402.

Biometrics device 302 also preferably includes a processing unit 408. Processing unit 408 optionally and preferably includes a processor circuit 410, a memory 412 and may optionally include an analog-to-digital converter circuit (A/D) 414. Some CMOS optical sensors provide a digital output signal, which means that A/D 414 may optionally not be required.

Memory 412 stores preferably information that is specific to processing unit 408, such as the algorithm for creating the BIdToken according to the present invention from the obtained biometric information as previously described. Memory 412 is optionally and preferably not writable after manufacture; optionally a separate volatile memory may also be included (not shown).

Biometric sensor 303 may optionally include a direct contact device instead of optical sensor imaging device 402. Direct contact capacitive chip fingerprint sensors can be obtained from SGS Thomson Microelectronics, of Phoenix Ariz., from Veridicom, Inc., of Santa Clara Calif. (USA), and from Harris Semiconductor, of Melbourne, Fl. (USA). A direct contact thermal sensor may also be used for fingerprint sensing.

Biometrics device 302 may optionally include a housing 416 which is preferably comfortably held in the hand, which optionally and preferably includes a keypad 420 for entering data and commands or any other suitable type of data entry interface, and a display 422 such as a liquid crystal display for example for displaying data being entered with keypad 420 and for displaying status signals to the user. Optionally data entry may be performed (additionally or alternatively) by implementing display 422 as a touch screen for example. Keypad 420 (or the previously described touch screen) can optionally be eliminated if data entry is not required; alternatively or additionally, the presence of keypad 420 means that optionally non-biometric identification reader 308 of gatekeeper module 304 may be eliminated (not shown), since a PIN could for example optionally be entered through keypad 420 (and/or through a touch screen or any other suitable data entry device).

Platen 404 is preferably located at the top of biometrics device 320 although optionally platen 404 may be placed in any suitable location, and is more preferably contoured for a finger. Platen 404 is also preferably slightly recessed in the housing to provide some protection from scratching.

Power may optionally be provided through a power source 424, which could for example comprise batteries and/or direct electrical DC power.

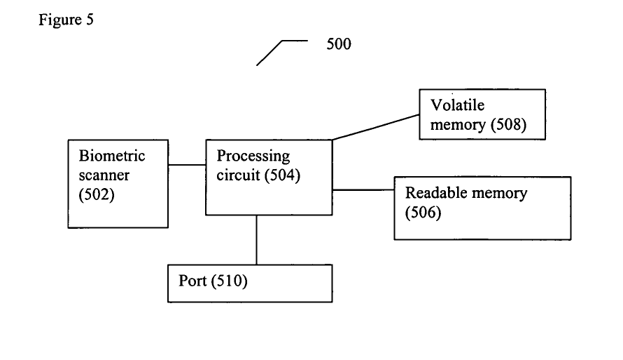

FIG. 5 is another exemplary device according to the present invention for operation alone or with the system of FIG. 3.

A portable personal identification device 500, for example for providing secure access to a host facility (not shown), preferably includes a biometric scanner 502, which may optionally be implemented as a camera or other image or biometric processing system capable of scanning a biometric trait of a user that is unique to the user.

A processing circuit 504 responsive to the biometric scan is adapted to compare individual biometric property in a closed loop with a “BIdToken” namely comparing the biometric scan results with a previously derived non-unique identifier, preferably a number. For example, if the token is a 4 digit number, then it is repeated or reiterated every 9999 different combinations.

The resultant number may optionally be stored by the user rather than being stored on device 500, such that device 500 optionally and preferably does not feature any type of permanently writable memory, but rather only a readable memory 506 (which may optionally be used to store the processes required for reading the biometric information and obtaining the resultant BIdToken for example) and a temporarily writable (volatile) memory 508. Upon request, the user would enter the BIdToken, for example manually and/or from a card or any other suitable entry mechanism, after which device 500 would be used to scan the biometric information of the user to verify the entered number.

This optional implementation of the present invention would eliminate the need for storing or presenting or creating any unique or non-unique biometric data representative of the biometric trait of a surveyed person that is indicative of the identity of the surveyed person. Instead, a comparison would be made between the entered number and the newly obtained number through scanning of the actual person; the comparison could optionally be made by using memory that is only temporarily writable, and which is wiped out once power is removed. Once the surveyed individual receives the specific BIdToken, he or she can now be verified for authentication.

Device 500 may also optionally comprise a port 510 through which communication is made, such that only certain types of data (such as the non-unique identifier) are preferably allowed to pass. Optionally, requests such as for example to access the stored method for determining the non-unique identifier would preferably be blocked at port 510.

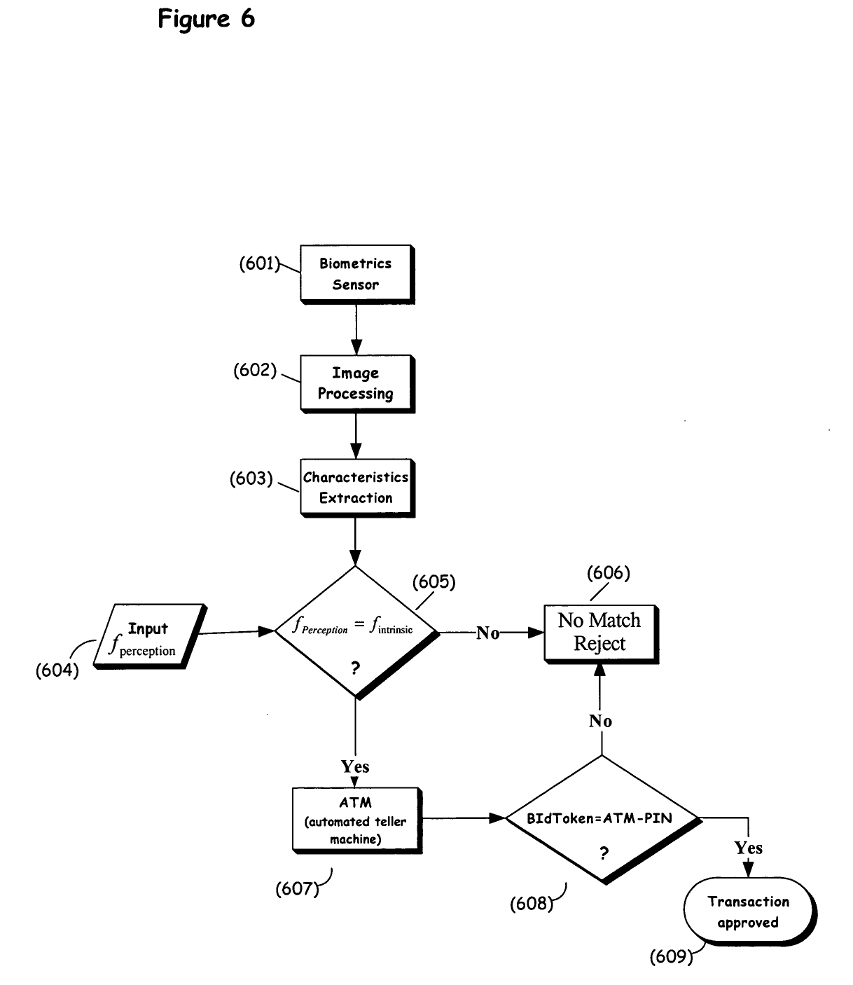

FIG. 6 shows a flowchart of an exemplary method for using a BIdToken with an ATM (cashpoint) machine according to the present invention. As shown, in stage 601 a biometrics sensor and/or scanner is used to obtain biometrics information from a user. In stage 602, image processing is performed. In stage 603, the BIdToken is determined (stages 601-603 may each be implemented as previously described; it should be noted that they are shown in a condensed format but that may optionally be performed as described with regard to FIG. 2 for example).

In stage 604, optionally and preferably the previously determined BIdToken of the user is provided as previously described, optionally and preferably by the user. According to this preferred embodiment, f_{perception} relates to a function which is optionally and preferably controlled by the user, for example by having the user remember the BIdToken as for any other password and/or PIN. Alternatively, the BIdToken may be optionally retained and accessed elsewhere, optionally by an entity other than the user. In stage 605, the currently obtained and the previously determined BIdToken are compared; if there is no match then there is preferably a rejection of the input information in stage 606.

If there is a match the method preferably continues to stage 607. In stage 607, a second form of identification is preferably provided by the user, for example in the form of a bank card to be inserted into the terminal and/or any other type of identification. This combination enables the user to be uniquely identified as previously described, even though the BIdToken is preferably non-unique. In stage 608, if the second form of identification matches the user details of the requesting user, such as the BIdToken optionally matching the PIN for example, then at least one user request is preferably executed by the ATM machine in stage 609 (for example by providing money to the user). If not then there is preferably a rejection as before for stage 606.

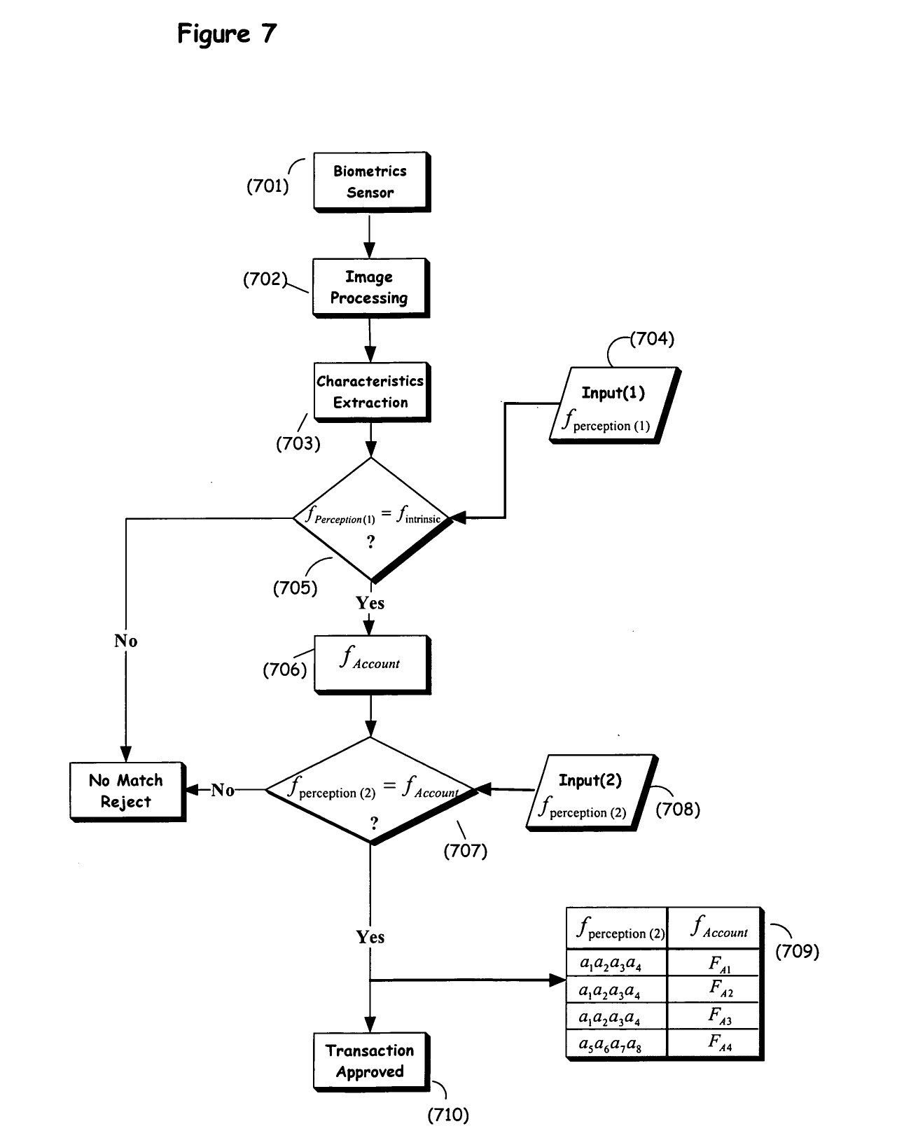

FIG. 7 shows a flowchart of an exemplary method for purchasing one or more items and/or performing a transaction with a BIdToken according to the present invention. Stages 701-705 optionally and preferably mirror (are performed similarly and/or identically to) stages 601-605 as described above.

In stage 706, the BIdToken is optionally and preferably compared to one or more stored BIdTokens to determine whether it matches a single account or multiple accounts. In stage 707, a process is preferably performed on the combination of the account number and the BIdToken to determine whether the account may be uniquely identified. In stage 708, the user preferably enters an account identifier such as an account number for example for unique identification of the account as part of the process of stage 707.

In stage 709, the entered account identifier such as an account number and BIdToken are shown to be correctly matched to a single unique account.

In stage 710, if the information matches, then the transaction is preferably approved; otherwise it is preferably rejected.

This embodiment of an exemplary method according to the present invention may optionally and preferably be used for a “cardless” transaction, such that the user may optionally not present a card or other physical device as part of the identification. Instead, such a method may optionally be used over the Internet, for e-commerce or for any type of cardless transaction, as the BIdToken is preferably non-unique, yet the combination of BIdToken and account identifier or other entered information preferably is unique. Optionally and preferably, the account identifier is itself unique.

While the invention has been described with respect to a limited number of embodiments, it will be appreciated that many variations, modifications and other applications of the invention may be made.

What is claimed is:

1. A method for creating a non-unique identifier for a user, comprising:
Obtaining unique biometric information from the user; and
Determining the non-unique token from said biometric information.

2. The method of claim 1, wherein said determining said non-unique token comprises a lossy method for losing at least some information.

3. The method of claim 2, wherein said unique biometric information is not stored permanently.

4. The method of claim 3, wherein said non-unique token is not stored.

5. The method of claim 4, wherein said non-unique token comprises a string selected from the group consisting of a symbolic string and a numeric string.

6. The method of claim 2, wherein said non-unique token is stored.

7. The method of claim 6, wherein storage of said non-unique token is controlled by the user.

8. The method of claim 7, wherein said storage comprises a physical object.

9. The method of claim 1, wherein said biometric information comprises at least one of a fingerprint, facial recognition, a voiceprint, EEG (brainwaves) trace signature, retinal eye scan, iris scan, hand geometry, palm vein pattern, signature creation speed, sign creation speed, signature image, sign image, keystroke pattern, teeth pattern, gait characteristics or odors or a combination thereof.

10. The method of claim 1, further comprising:
Determining access to a restricted resource at least partially according to the non-unique token.

11. The method of claim 10, wherein said restricted resource is selected from the group consisting of a bank account, a financial system, a computer system, and a secure host facility.

12. The method of claim 11, wherein said secure host facility is selected from the group consisting of a bank, a store, a military base, an automobile, a home security system, a gate, or any other facility restricting access to selected individuals.

13. The method of claim 10, wherein storage of the non-unique token is controlled by said restricted resource.

14. The method of claim 1, wherein said determining the non-unique token from said biometric information comprises processing said unique biometric information for reproducibly producing the non-unique token according to at least one biometric characteristic.

15. The method of claim 14, wherein said processing comprises converting said unique biometric information to at least one of a numeric string or a symbolic string.

16. The method of claim 15, wherein said converting is for at least one numeric string and said processing further comprises performing at least one mathematical operation for reducing an amount of information in said numeric string.
